(19) United States
(12) Patent Application Publication
(10) Pub. No.: US 2013/0179049 A1
(43) Pub. Date: Jul. 11, 2013

(54) METHOD AND DEVICE FOR OPERATING A LUBRICATING SYSTEM OF A COMBUSTION ENGINE

(71) Applicant: Ford Global Technologies, LLC, Dearborn, MI (US)

(72) Inventors: Klemens Grieser, Langenfeld (DE); David Karl Bidner, Livonia, MI (US); John Eric Rollinger, Sterling Heights, MI (US); Steve Garrett, Darlington (GB); Yihua Eva Barber, Novi, MI (US); Ben Xuehai Yi, Canton, MI (US); John Smiley, Southfield, MI (US); Adrian Petrut, Canton, MI (US)

(73) Assignee: FORD GLOBAL TECHNOLOGIES, LLC, Dearborn, MI (US)

(21) Appl. No.: 13/740,098

(22) Filed: Jan. 11, 2013

(30) Foreign Application Priority Data
Jan. 11, 2012 (DE) 102012200279.0

(51) Int. Cl. F02D 45/00

(52) U.S. Cl. CPC F02D 45/00
USPC 701/102

(57) ABSTRACT

The application relates to a method for operating a lubricating system of a combustion engine in a motor vehicle, the engine having a variably controllable oil pump and a plurality of piston cooling jets. The oil pressure may be adjusted based on operating conditions to activate and de-activate the piston cooling jets when needed.

### CROSS REFERENCE TO RELATED APPLICATIONS

The present application claims priority to German Application 102012200279.0, filed on Jan. 11, 2012, the entire contents of which are hereby incorporated by reference for all purposes.

The present invention relates to a method and a device for operating a lubricating system of a combustion engine that is equipped with a variable control oil pump.

### BACKGROUND AND SUMMARY

In the pursuit of better fuel efficiency, internal combustion engines in vehicles have been getting consistently smaller despite unchanged performance demands. This development has relied upon engines operating with increased rotational speeds and loads. These increases have caused a corresponding increase in the heat produced by the engine during operation and thus the demands on the cooling system to prevent over-heating. Piston cooling can be, in part, by piston spraying devices wherein piston cooling jets (PCJ) are used to generate jets of oil onto the underside of the pistons. This oil may then absorb the heat of combustion before draining away, carrying heat away from and thus cooling the piston. The oil delivered to the PCJ is accelerated via an oil pump that may have variable oil pressure such that the oil pressure and/or the pump output of the oil pump is tailored to suit the actual oil requirement of the engine in order to reduce the energy consumption of the oil pump.

Methods for adjusting oil pump output are addressed in DE 2005 034 712 A1 wherein an actuator is provided with an adjusting force generated with reference to the operating parameters of the engine, such as the determined oil temperature or rotational speed or load in order to adjust chamber volume.

In other examples, such as WO 2007/042067 A1, a lubricating system for an engine uses an oil pump coupled to the bearing interface of the crankshaft and an auxiliary output connected to at least one piston cooling jet via a main line. In so doing, the oil flow into the piston cooling jets is controlled by way of a proportional valve in response to operating parameters of the engine, such as the oil temperature, the rotational speed or the required torque.

The problem arises, when operating piston cooling jets of this type, that the oil pump must be embodied to allow additional oil flow rate into the piston cooling jets, however, permanently increased oil flow rate results in higher friction losses. If the variation of these friction losses corresponds with the output rating of the oil pump it can, in turn, lead to fluctuations in the idling rotational speed and consequently to malfunctions in the operation of the combustion engine. Therefore, it is advantageous to reduce the friction losses in the combustion engine when using variable oil pumps.

The inventors have recognized the above issues and addressed these losses by providing a method and a device for operating a lubricating system of an engine having a variably controllable oil pump and a plurality of piston cooling jets in order to cool at least one piston of the combustion engine, where it is possible to reliably prevent damage to the piston as a result of heat while simultaneously rendering it possible to save fuel and achieve a efficient operation.

Example methods and systems utilize a variably controllable oil pump and a plurality of piston cooling jets in order to cool at least one piston of the combustion engine, wherein the piston cooling jets are selectively activated or deactivated by varying the oil pressure provided by the oil pump in response to the engine load threshold, engine knocking, and/or the heating of a passenger cabin. In so doing, the oil pump acts as a switching device and is used in accordance with piston cooling jet activation and/or deactivation methods in order to effectively prevent damage to the pistons as a result of heat while ensuring the combustion engine operates in a fuel-saving and efficient manner.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

FIG. 1 is an example embodiment of an engine system of a vehicle.

FIG. 2 is an example method of operating an engine, such as the engine of FIG. 1.

### DETAILED DESCRIPTION OF FIGURES

During the operation of an engine equipped with piston cooling jets, it is not necessary at all times to provide an oil flow rate that remains constantly high. By using the variably controllable oil pump, in high load operating times oil pressure may be increased in a purposeful manner to above the passive switch-on threshold of the piston cooling jets, but moreover, oil pressure may be decreased when the operation is not a high load operation providing a more advantageous effect on consumption.

In accordance with one embodiment, the selective activation or deactivation of the piston cooling jets may occur, in each case, in a pressure-based manner by way of at least one spring-loaded valve responsive to the oil pump pressure actuated by the control system.

In accordance with one embodiment of the invention, it is also possible to take into consideration the situation that the moment of ignition, in which knocking, i.e. an uncontrolled combustion or self-ignition of the fuel occurs, in other words, the so-called borderline ignition setting (BDL), is dependent upon the piston temperature. It is possible by suitably activating the piston cooling jets to cool the piston and to achieve a displacement of the moment of ignition by at least 1 degree, in particular by at least 2 degrees, of crank angle, whereby in turn the saving on fuel is improved and engine degradation reduced.

The above described displacement of the moment of ignition as a result of selectively activating the piston cooling jets occurs at relatively low loads and relatively low rotational speeds, i.e. in a continuous range that is selected with respect to the saving on fuel, in which range the pistons do not need to be cooled owing to the mechanical conditions.

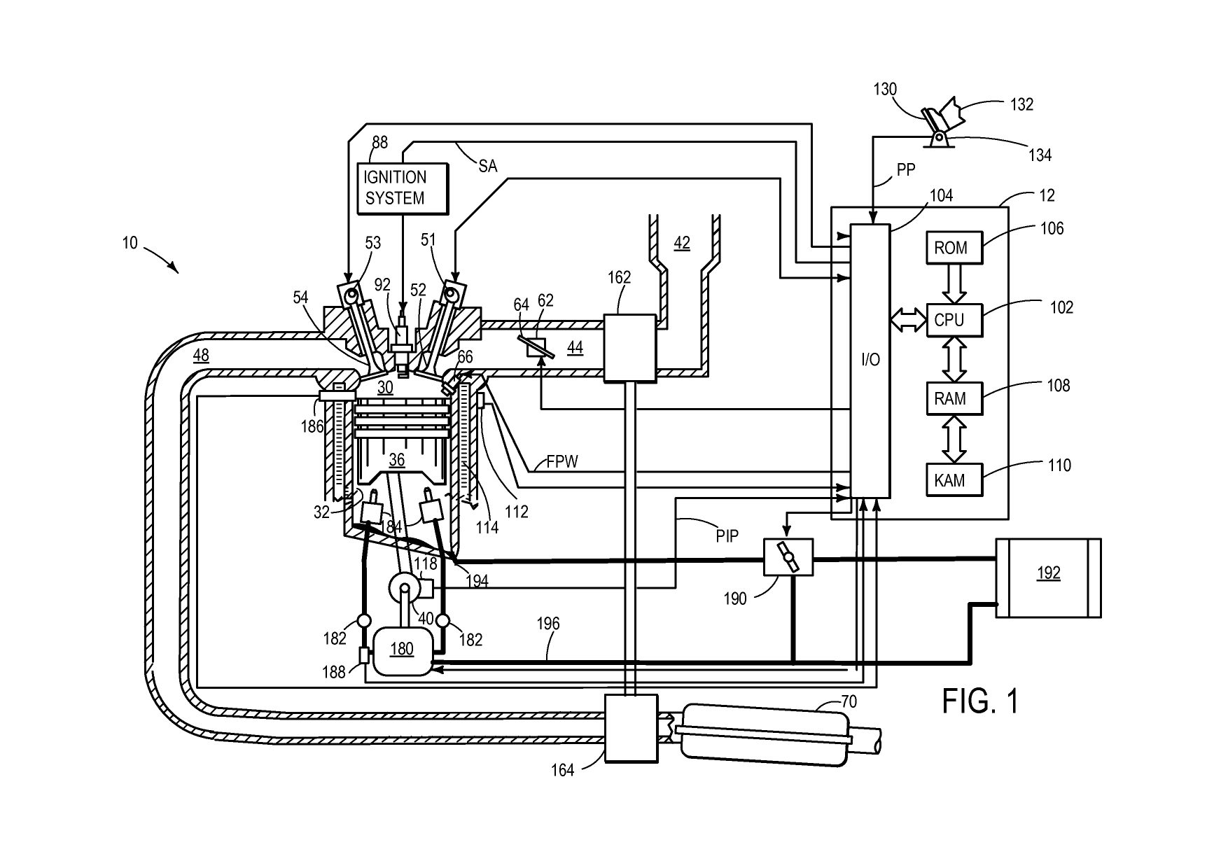

FIG. 1 is a schematic diagram showing one cylinder of multi-cylinder engine 10, which may be included in a propulsion system of a vehicle. Engine 10 may be controlled at least partially by a control system including controller 12 and by input from a vehicle operator 132 via an input device 130. In this example, input device 130 includes an accelerator pedal and a pedal position sensor 134 for generating a proportional pedal position signal PP. It may also include a cabin temperature control device such as a thermostat control (not shown). The engine 10 may include a multiplicity of cylinders each with a combustion chamber 30 including combustion chamber walls 32 with piston 36 positioned therein. The of reciprocation motion of piston 36 may be translated into rotational motion of a crankshaft via mechanical coupling. Crankshaft 40 may be coupled to at least one drive wheel of a vehicle via an intermediate transmission system.

Air for combustion may be delivered to combustion chamber 30 by way of an intake manifold 44 via intake passage 42 and may be exhausted after combustion via exhaust passage 48. Intake manifold 44 and exhaust passage 48 can selectively coupled to combustion chamber 30 via respective intake valve 52 and exhaust valve 54. Combustion chamber 30 may include two or more intake valves and/or exhaust valves (not shown).

Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary intake valve 52 and exhaust valves 54 position.

Engine 10 may further include a compression device such as a turbocharger or supercharger including compressor 162 coupled to intake manifold 44. For a turbocharger, compressor 162 may be, in some part, driven by a turbine 164 coupled to an exhaust passage 48. For a supercharger, compressor 162 may be at least partially driven by the engine and/or an electric machine, and may not include a turbine. The amount of intake air compression via a turbocharger or supercharger may be varied by controller 12.

Fuel injector 66 may be mounted in the side of the combustion chamber or in the top of the combustion chamber and may directly inject fuel into combustion chamber 30 in proportion to the pulse width of signal FPW received from controller 12 in a manner known as direct injection. Alternatively or additionally a fuel injector may be arranged in intake manifold 44 and inject fuel into the intake port upstream of combustion chamber 30.

Intake passage 42 may include a throttle 62 having a throttle plate 64 and varied by controller. In this manner, throttle 62 may be operated to vary the intake air provided for combustion. Ignition system 88 may provide an ignition spark for combustion via spark plug 92 actuated by controller 12 and may be varied in response to operating conditions.

Variable flow oil pump 180 can be coupled to crankshaft 40 to provide power. Variable flow oil pump 180 may include a plurality of internal rotors (not shown) that are eccentrically mounted and actuated by controller 12 to change the position relative to one or more other rotors thereby adjusting output pressure. For example, the electronically controlled rotor may be coupled to a rack and pinion assembly that is adjusted via the controller 12.

It will be appreciated that any suitable variable flow oil pump configuration may be implemented to vary the oil pressure and/or oil flow rate. In some embodiments, instead of being coupled to the crankshaft 40 the variable flow oil pump 180 may be coupled to a camshaft, or may be powered by a different power source, such as a motor or the like.

Piston cooling jets 184 may be coupled downstream of an output of the variable flow oil pump 180 to selectively receive oil from the variable flow oil pump 180. In some embodiments, the piston cooling jets 184 may be incorporated into the combustion chamber walls 32 of the engine cylinder and may receive oil from galleries formed in the walls. The piston cooling jets 184 may be operable to inject oil from the variable flow oil pump 180 onto an underside of piston 36 to provide cooling effects. Furthermore, through reciprocation of piston 36, oil is drawn up into combustion chamber 30 to provide cooling effects to walls of the combustion chamber 30.

A spring actuated valve 182 may be positioned between the output of the variable flow oil pump 180 and the piston cooling jets 184 to activate or deactive piston cooling in response to pressure from oil pump 180.

Vibration sensor 186 is shown positioned in combustion chamber wall 32 and may provide an indication of vibration in the combustion chamber to the controller 12. The vibration sensor 186 may be used to determine an indication of pre-ignition or engine knock in the combustion chamber 30. The indication of pre-ignition may be determined from larger vibrations that occurring earlier in the engine cycle (prior to spark) and the indication of engine knock may be determined from smaller vibrations that occur later in the engine cycle (subsequent to spark). Although a vibration sensor is provided as an example to determine an indication of pre-ignition and/or engine knock, it will be appreciated that any suitable sensor may be used to provide an indication of pre-ignition or engine knock.

Exhaust gas sensor 126 is shown coupled to exhaust passage 48 upstream of emission control device 70. Emission control device 70 is shown arranged along exhaust passage 48 downstream of exhaust gas sensor 126. Device 70 may be a three way catalyst (TWC), NOx trap, various other emission control devices, or combinations thereof.

Controller 12 is shown in FIG. 1 as a microcomputer, including microprocessor unit 102, input/output ports 104, an electronic storage medium for executable programs and calibration values shown as read only memory chip 106 in this particular example, random access memory 108, keep alive memory 110, and a data bus. Controller 12 may receive various signals from sensors coupled to engine 10, in addition to those signals previously discussed, including measurement of inducted mass air; a profile ignition pickup signal from Hall effect sensor 118 (or other type) coupled to crankshaft 40; throttle position from a throttle position sensor; and absolute manifold pressure signal. Engine speed signal, RPM, may be generated by controller 12.

Storage medium read-only memory 106 can be programmed with computer readable data representing instructions executable by processor 102 for performing the methods described herein as well as other variants that are anticipated but not specifically listed.

Furthermore, controller 12 may receive signals that may be indicative of pre-ignition or engine knock in the combustion chamber 30. For example, engine coolant temperature from temperature sensor 112 coupled to water jacket 114 may be sent to controller 12 to indicate whether or not the temperature of the combustion chamber is in range in which pre-ignition may occur. Controller 12 may adjust oil injection in response to an indication of pre-ignition that includes an engine temperature being greater than a threshold. Additionally or alternatively, vibration sensor 186 may send a signal indicating pre-ignition in response to detecting vibrations that correspond a vibration profile of pre-ignition (e.g., higher amplitude, occur earlier in the engine cycle, etc.). Controller 12 may receive an indication of oil pressure from pressure sensor 188 positioned downstream of the output of the variable flow oil pump 180.

By varying the oil pressure provided by the oil pump 180, piston cooling jets may be selectively activated or deactivated the in response to the engine load threshold valve being exceeded or not achieved. This pressure may be increased or decreased in response to a control system 12 receiving input from any of the aforementioned sensors or sensors not otherwise mentioned that establish a predetermined engine load threshold value is exceeded or not achieved. If pressure in the oil pump is such that the valve 182 to the piston cooling jet 184 is closed it may be increased so that the valve 182 is open is it is established that the threshold is reached. If pressure in the oil pump is such that the valve 182 to the piston cooling jet 184 is open it may be decreased so that the valve 182 is closed is it is established that the threshold is not achieved. In accordance with one embodiment, the selective activation or deactivation of the piston cooling jets 184 occurs in each case in a pressure-based manner by way of at least one spring-loaded valve.

During the operation of an engine equipped with piston cooling jets 184, it is not necessary at all times to provide an oil flow rate that remains constantly high. Using the variably controllable oil pump 180 in high load operating times to increase the oil pressure in a purposeful manner to above the passive switch-on threshold of the piston cooling jets 184, but moreover, to provide a lower oil pressure that has a more advantageous effect on the consumption, wherein the piston cooling jets 184 are deactivated. In so doing, the oil pump 180 which is to a certain extent also a switching device is used in accordance with the invention in order to selectively activate and/or deactivate the piston cooling jets 184, in order to effectively prevent degradation to the piston 36 as a result of heat whilst enabling the engine to operate in a fuel-saving and effective manner.

In accordance with one embodiment of the invention, it is also possible to take into consideration the situation that the moment of ignition, in which knocking, i.e. an uncontrolled combustion or self-ignition of the fuel occurs, in other words, the so-called borderline ignition setting (BDL), is dependent upon the piston temperature. It is possible by suitably activating the piston cooling jets 184 to cool the piston 36 and to achieve a displacement of the moment of ignition by at least 1 degree, in particular by at least 2 degrees, of crank angle, whereby in turn the saving on fuel is improved.

The above described displacement of the moment of ignition as a result of selectively activating the piston cooling jets 184 occurs at relatively low loads and relatively low rotational speeds, i.e. in a continuous range that is preferred with respect to the saving on fuel, in which range the pistons do not need to be cooled owing to the mechanical conditions. This activation may occur upon establishing the start of knocking or existence of knocking during the operation of the combustion engine.

Consequently, if, for example, a sensor indicates the existence of knocking and/or the start of knocking, the piston cooling jets 184 may be automatically switched on and/or activated depending upon the prevailing operating state in order to reduce the knocking tendency by way of a displacement of the moment of ignition. In this respect, measurements have indicated that with the aid of the piston cooling jets 184 a displacement of the moment of ignition can achieve a displacement of the upper limit of ignition up to 2 degrees of crank angle for rotational speeds of less than 3,000 rotations per minute. The above described activation of the piston cooling jets 184 can occur, in particular, in an operational phase in which it is actually not necessary to operate the piston cooling jets for the purpose of protecting and/or cooling the piston.

The aspect of reducing the knocking tendency as a result of the operation of the piston cooling jets 184 is, moreover, fundamentally also advantageous independently of the previously described activation and/or deactivation of the piston cooling jets 184 in dependence upon the engine load threshold value being exceeded or not achieved.

The pre-ignition or knock abatement measures may be in addition to other measures actuated by the control system 12. These additional measures may include fuel injector 66 varying fuel injection in different cylinder according operating conditions. For example, controller 12 may command fuel injection be stopped in one or more cylinders as part of pre-ignition abatement operations so that combustion chamber 30 is allowed to cool. Further, intake valve 52 and/or exhaust valve 53 may be opened in conjunction with the stoppage of fuel injection to provide intake air for additional cooling. Further, ignition timing may be advanced or retarded in response to indication of engine knock or pre-ignition.

In accordance with one embodiment, the method may establishing whether there is a requirement to warm up the passenger internal compartment of the motor vehicle; and selectively activating or deactivating the piston cooling jets in dependence upon the presence of this requirement. The heating of a passenger compartment may be initiated by operator input 104 via control system 12. The control system 12 may actuate a thermostat 190 that controls the flow of heated oil to a heating core 192 wherein the heated oil is coupled to oil pan 194 collecting oil that has been previously sprayed onto piston 36 by piston cooling jets 184.

This is advantageous because, following the cold start-up of an engine, the amount of heat available for the first few minutes is limited, wherein it is fundamentally desirable to rapidly warm the cooling fluid of the engine 10, in order, for example, to warm up the passenger internal compartment more rapidly.

Heat is generally directed from the water jacket 114 to the oil circuit 196 by activating the piston cooling jets, as a consequence of which the cooling fluid heats up at a slower rate. Based on this consideration the piston cooling jets may be operated selectively during the warm-up phase of the engine 10 in such a manner that when the operating temperatures are comparatively low, on the one hand, an appropriate saving on fuel is achieved and, on the other hand, heating energy can be made available in order to adjust the temperature in the passenger internal compartment.

In other words, the piston cooling jets 184 may be each selectively switched on or off in such a manner that the warming up of the passenger internal compartment is improved and/or accelerated by way of the heating core 192.

The above described activation of the piston cooling jets for the purpose of warming up the passenger internal compartment can occur, in particular, in an operational phase in which it is actually not necessary to operate the piston cooling jets for the purpose of protecting and/or cooling the piston.

The precise implementation and/or calibration of this selective operation of the piston cooling jets is suitably selected in dependence upon the particular aspects of the respective cooling medium system and upon the embodiment of the oil cooler and the arrangement of the heating devices. If a water-oil cooler is not arranged upstream of the heating device, the heating of the passenger internal compartment can be intensified, in that the piston cooling jets 184 are switched off and/or not supplied with energy. If, on the other hand, a water-oil cooler is arranged upstream of the heating device, the heating of the passenger internal compartment can be intensified in that the piston cooling jets are switched on. If, however, the desire is to save on fuel, the temperature of the cooling water jacket is of critical importance, so that it is not desirable to switch on the piston cooling jets.

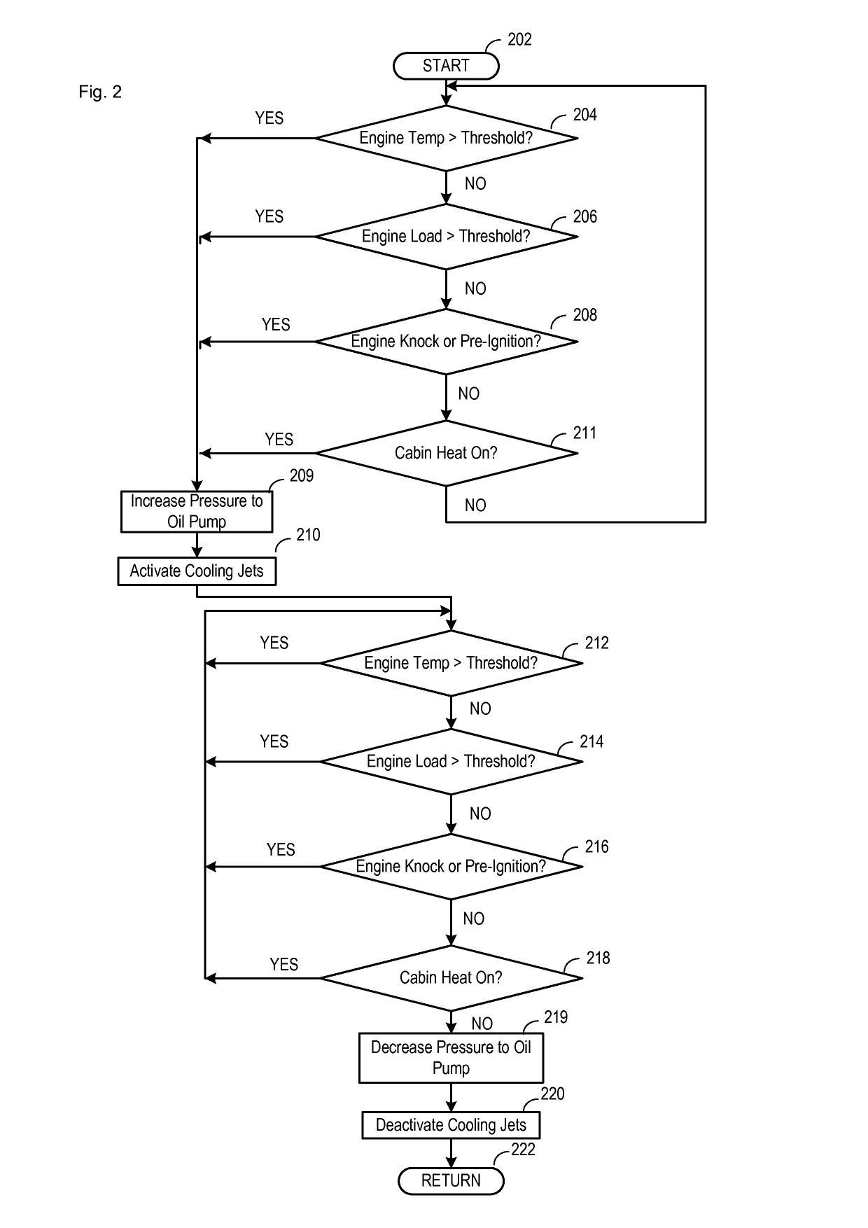

Therefore it is possible to prevent damage to the piston as a result of heat to improve the operating characteristics of the combustion engine whilst reducing friction losses and simultaneously rendering it possible to operate in a fuel-saving and robust manner. This may be achieved by the sample method of FIG. 2.

In the sample method of FIG. 2, piston cooling sensors may be activated via the controller if the temperature within the engine has exceeded a warm-up threshold at 204. This threshold may be pre-determined to prevent engine degradation whilst allowing for the engine to rapidly heat to a desired operating temperature. If the temperature threshold has not been reached it may be determined if an engine load threshold has been achieved at 206. If the threshold has been achieved the pistons cooling jets may be activated at 210, else it may be determined if engine knock or pre-ignition has been detected. If the control system has determined the presence of pre-ignition or knock the piston cooling jets may be activated at 210. Else, it may be determined if heat is to be delivered to the passenger cabin at 209, this may be initiated by an operator input to the control system. If heating of the passenger cabin is desired the piston cooling jets may be activated at 210. This is advantageous because, in many passenger cabin heating systems, heat to the passenger cabin is delivered exclusively or in part by the oil circuit. However, if the oil is not allowed to be heated by the engine by contact with the piston the oil is not heated and the cabin may not warm. If none of the above conditions are determined to have been met the process may repeat.

The piston cooling jets may be activated by increasing the pressure of an oil pump at 211 coupled to the piston cooling jets. A pressure activated spring valve may then open to allow oil to flow to one or more of the piston cooling jets.

In the case of activation of the piston cooling jets at 210, it may again be determined if the engine is above a temperature threshold at 212, if the engine the engine remains above that threshold the process may return to 212. Else, it may be determined if the engine is operating at a load above a predetermined threshold at 214, if the engine is operating above the threshold the process may return to 212. Else, it may be determined if the control system has received indication of engine knock or pre-ignition at 216, if engine knock or pre-ignition is indicated the process may return to 212. Else, it may be determined if heating of the passenger cabin is desired at 218. This determination may be made by the above methods. If passenger cabin heating is desired the method may return to 212, else the pressure of the oil pump actuated by the control system may be decreased at 219. The pressure may be decreased to such an extent that the pressure activated valve coupling the oil pump to the piston cooling jets may close and the piston cooling jets deactivate. Upon deactivation the process may return at 222 to start 202.

Additional adjustment of the oil pressure for purposes other than engine warm-up and piston cooling jet activation/deactivation may be provided. For example, during a first mode, engine oil pressure may be adjusted to be increased/decreased above/below a piston cooling jet activation threshold responsive to operating conditions in order to change the state of the piston cooling jets. However, the variable oil pump may adjust oil pressure for additional reasons at levels above and below the piston cooling jet activation threshold during a second mode. For example, the method may include adjusting the engine oil pressure via the variable oil pump responsive to engine operating conditions, including increasing oil pressure from above the piston cooling jet activation threshold to an even higher pressure responsive to engine speed above an upper threshold; and decreasing oil pressure from below the piston cooling jet activation threshold to an even lower pressure responsive to engine speed below a lower threshold.

It will be appreciated by those skilled in the art that although the subject matter of this disclosure has been described by way of example with reference to one or more embodiments it is not limited to the disclosed embodiments and that alternative embodiments could be constructed without departing from the scope of disclosed subject matter as defined by the appended claims.

1. A method for operating a lubricating system of a combustion engine in a motor vehicle, the combustion engine comprising a variably controllable oil pump and a plurality of piston cooling jets in order to cool at least one piston of the combustion engine, comprising:
establishing whether during the operation of the combustion engine a predetermined engine load threshold value is exceeded; and
selectively activating and deactivating the piston cooling jets by varying the oil pressure provided by the oil pump in response to the engine load and threshold value.

2. The method as claimed in claim 1, wherein the selective activation and deactivation of the piston cooling jets occurs in each case in a pressure-based manner by way of at least one spring-loaded valve.

3. The method as claimed in claim 2, further comprising
establishing a start of knocking or existence of knocking during the operation of the combustion engine; and
activating the piston cooling jets responsive to the knocking by increasing engine oil pressure.

4. A method for operating a lubricating system of a combustion engine, the combustion engine comprising a variably controllable oil pump and a plurality of piston cooling jets in order to cool at least one piston of the combustion engine, comprising:
varying operation of the piston cooling jets in response to at least one operating parameter of the combustion engine;
establishing a start of knocking or existence of knocking during the operation of the combustion engine; and
activating the piston cooling jets responsive to the knocking.

5. The method of claim 4, further comprising:
establishing whether there is a requirement to warm up the passenger internal compartment of the motor vehicle; and
selectively activating and deactivating the piston cooling jets in dependence upon the presence of the requirement.

6. The method of claim 5 wherein the selective activation of the piston cooling jets occurs at least at times in an operating phase of the combustion engine in which the piston cooling jets are not required in order to cool the piston, with piston temperature less than a threshold piston temperature.

7. A method, comprising:
adjusting a piston oil jet amount responsive to engine warm-up conditions, engine knocking, and passenger compartment conditions by adjusting oil pressure via a variable oil pump.

8. The method of claim 7 further comprising:
increasing oil pressure responsive to engine knocking increasing;

9. The method of claim 7 further comprising:
decreasing oil pressure responsive to engine warm-up and/or cold starting conditions;

10. The method of claim 7 further comprising:
increasing oil pressure responsive to engine load surpassing an upper load threshold;

11. The method of claim 7 further comprising:
decreasing oil pressure responsive to engine load falling below a lower load threshold;

12. The method of claim 7 further comprising:
increasing oil pressure responsive to increased heat requirements to a passenger compartment.

13. The method of claim 7 further comprising:
decreasing oil pressure responsive to decreased heat requirements to a passenger compartment.

14. The method of claim 7 further comprising:
decreasing oil pressure responsive to decreased engine knocking.

15. The method of claim 7 further comprising direct injecting fuel into cylinders of the engine and spark-igniting the fuel, the engine being boosted by a turbocharger.

16. The method of claim 7 further comprising increasing and decreasing oil pressure responsive to engine temperature.

17. The method of claim 7 further comprising:
increasing oil pressure responsive to engine knocking increasing;
decreasing oil pressure responsive to engine warm-up and/or cold starting conditions;
increasing oil pressure responsive to engine load surpassing an upper load threshold;
decreasing oil pressure responsive to engine load falling below a lower load threshold;
increasing oil pressure responsive to increased heat requirements to a passenger compartment.
decreasing oil pressure responsive to decreased heat requirements to a passenger compartment, the increasing oil pressure including increasing oil pressure above a piston cooling jet activation threshold, the decreasing including decreasing oil pressure below the piston cooling jet activation threshold.

18. The method of claim 17 further comprising adjusting the engine oil pressure via the variable oil pump responsive to engine operating conditions, including increasing oil pressure from above the piston cooling jet activation threshold to an even higher pressure responsive to engine speed above an upper threshold; and decreasing oil pressure from below the piston cooling jet activation threshold to an even lower pressure responsive to engine speed below a lower threshold.
